(19) United States
(12) Patent Application Publication
(10) Pub. No.: US 2010/0143056 A1
(43) Pub. Date: Jun. 10, 2010

(54) Insert for a Boring Device, In Particular for a Countersink Borer With Depth Stor or for a Pressure Die Bush

(76) Inventor: Harald Schüler, Hamburg (DE)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 11/922,679

(22) PCT Filed: Jun. 22, 2006
(86) PCT No.: PCT/EP2006/006018

§ 371 Date: Dec. 19, 2007

(30) Foreign Application Priority Data
Jun. 23, 2005 (DE) 10 2005 029 134.1

(51) Int. Cl. B23B 49/02

(52) U.S. Cl. 408/110

(57) ABSTRACT

The invention relates to an insert (1) for a boring device, in particular for a countersink borer with depth stop or for a pressure die bush, comprising a substantially circular base body (2) and a base body bore (3) disposed approximately centrally therein for passing a borer (11) and/or a countersink borer through it. According to the invention, an underside (6) of the base body (2) is in contact with a surface (13) of a component (12) for protecting said surface (13) and a base diameter (5) of the base body bore (3) is greater or equal to a diameter (15) of a bore (14) to be created in a component (12) or greater or equal to an opening diameter (17) of a countersink bore (16).

### REFERENCE TO RELATED APPLICATIONS

The present application claims the benefit and the filing date of German Patent Application 10 2005 029 134.1 filed 23 Jun. 2005, the disclosure of which is hereby incorporated herein by reference.

### FIELD OF THE INVENTION

The invention relates to an insert for a boring device, in particular for a countersink borer with depth stop or for a pressure die bush, comprising a substantially circular base body and a base body bore disposed approximately centrally therein for passing a borer and/or a countersink borer through it.

### TECHNOLOGICAL BACKGROUND

When creating bores or countersink bores in metallic components, chips are generally generated, which, as a result of the rotation of the borer on the component surface to be processed, may cause undesirable damage, in particular, scratch or grind marks. The aluminum plates used in area of aircraft construction often comprise delicate surface coatings, which shall not be damaged by rotating, chips, since this would require costly post-processing steps.

The previously known embodiments of pressure die bushes (German: Druckstempelbuchse) or countersink borers with depth stop, which are, for example, utilized for creating such types of bores or countersink bores in aluminum plates, may not provide any help in that respect.

### SUMMARY OF THE INVENTION

It may be desirable to prevent damage to component surfaces by rotating boring chips or suchlike when creating bores or countersink bores, in particular by means of countersink, borers with depth stop or by means of pressure die bushes. Furthermore, it may be desirable to configure the insert in such way that it may be simple and cost effective to produce and it may also be easy to replace when it reaches the wear limit.

According to an exemplary embodiment of the present invention, an insert for a boring device is provided, in particular for a countersink borer with depth stop or for a pressure die bush, comprising a substantially circular base body, and a base body bore disposed approximately centrally in the base body for passing a borer and/or a countersink borer through it, wherein an underside of the base body is in contact with a surface of a component to be processed for protecting said surface, and wherein a base diameter of the base body bore is greater or equal to a diameter of a bore to be created in the component or greater or equal to an opening diameter of a countersink bore.

As a result of an underside of the base body being in contact with a surface of a component to be processed for protecting said surface and a base diameter of the base body bore being greater or equal to a diameter of a bore to be created in the component or greater or equal to an opening diameter of a countersink bore, damage to the component surface by rotating boring chips may be prevented by the insert to a large extent, due to the almost complete coverage of the component surface by the insert outside of the actual processing area.

According to another exemplary embodiment of the invention, the base diameter of the base bore has a diameter which is approximately equal to the countersink bore diameter or the diameter of the bore or countersink bore to be created in the component, because this may ensure that the component surface is nearly completely covered by the insert and therefore protected against damage by rotating boring chips.

According to a further exemplary embodiment of the invention, the base body bore is tapered.

This embodiment may allow in particular also the use of a countersink borer or a borer with a larger diameter, without the occurrence of undesired material ablation and increased wear as a result of using the borer. Moreover, a borer may generally get jammed or stuck less frequently in a tapered configuration than in a cylindrical (guide) bore with no taper.

In accordance with a further exemplary embodiment of the inventive insert, the base body is releasably mounted in the boring device by press fitting.

The insert may hereby be easily replaceable. This may be particularly important when the insert is worn from longer use and its protective effect lessens as a result thereof.

According to a further exemplary embodiment of the invention, the base body comprises at least one circumferential step for press fitting in the boring device. This embodiment ensures firm seating of the base body being press fitted in the boring device. To accomplish this, the circumferential step has a marginally greater diameter than an inner diameter of the boring device, for example in form of a pressure die bush, so that a slight press fit is obtained. Other fastening types are equally possible, for example by way of a circumferential locking tab mounted on the insert, which is configured so that it can be inserted at least area-wise in a positively locking manner in a corresponding circumferential depression within the boring device.

In accordance with a further exemplary embodiment of the invention, the base body of the inventive insert comprises a soft plastic material, in particular polyethylene, polypropylene, PTFE or suchlike. Damage of the component surface by the insert may hereby be prevented. If required, the plastic material may be provided with fiber reinforcement for extending the lifetime. Furthermore, using a plastic material may enable the production of the insert in large quantities and in a simple fashion, for example by way of injection molding.

In accordance with a further exemplary embodiment of the invention, the base body of the insert comprises a soft metallic material, in particular aluminum, brass, copper or suchlike.

In comparison with an insert comprising a plastic material, this embodiment may ensure a longer lifetime. Alternatively, the insert may also comprise a metallic material, wherein a thin coating comprising a soft plastic material made of, for example, polyethylene, polypropylene, PTFE or suchlike, is applied solely on the area of an underside of the insert.

### BRIEF DESCRIPTION OF THE DRAWINGS

FIG. 1 shows a cross section through an insert according to the invention,

FIG. 2 shows a plan view on the insert and

FIG. 3 shows a cross section through a pressure die bush comprising a press fitted insert, with the insert being in contact with a component surface.

In the drawing, the same reference numerals represent the same elements.

### DETAILED DESCRIPTION OF EXEMPLARY EMBODIMENTS

FIG. 1 shows a cross section through the insert 1 according to an exemplary embodiment of the invention. The insert 1 comprises a substantially disk shaped base body 2. The base body 2 comprises a tapered base body bore 3, which serves to introduce through it a bore or a countersink bore for processing a component. The insert 1 is, in relation to the rotating borer, firmly mounted in a boring device, in particular in form of a countersink borer or a pressure die bush. As a result of the strong tapering of the base body bore 3, an opening diameter 4 of the base body bore 3 is considerably greater than a base diameter 5 of the base body bore 3. With an underside 6, the base body 2 bears on a component to be processed which is not shown in FIG. 1. The component surface, except the area to be processed or the area of the base body bore 3, is thereby covered by the insert 1 and thus completely protected against damage by rotating boring chips or suchlike. The base body 2 further comprises a circumferential step 7, which is used for press fitting in particular a countersink borer, a pressure die bush or suchlike in a boring device not shown.

The base body 2 is comprised of a soft plastic material, for example polyethylene, polypropylene, PTFE or suchlike. It is furthermore possible to produce the base body 2 also with a soft metallic material, for example aluminum, brass, copper or suchlike. The use of a metallic material has the advantage of increased wear resistance. In contrast thereto, using a plastic material enables cost-effective production of the base body 2 in very large quantities, for example by way of injection molding. In a further alternative embodiment, the base body 2 is comprised of a metallic material, which is coated in the area of the underside 6 with a sliding plastic material, in particular with polyethylene, polypropylene, PTFE or suchlike. In this way it may be possible to combine the individual specific advantages of an all-plastic construction of the base body 2 with those of an all-metal construction of the base body 2.

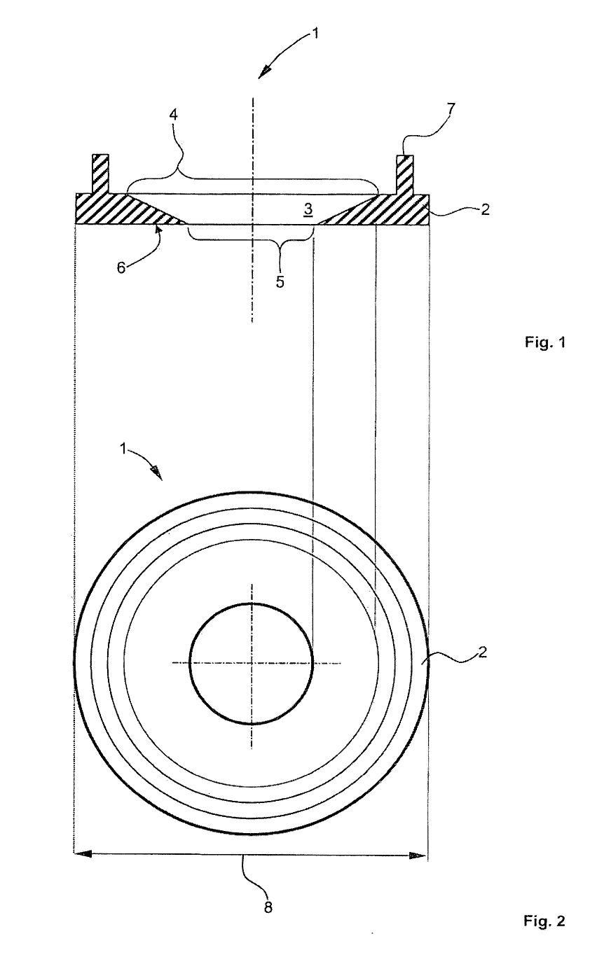

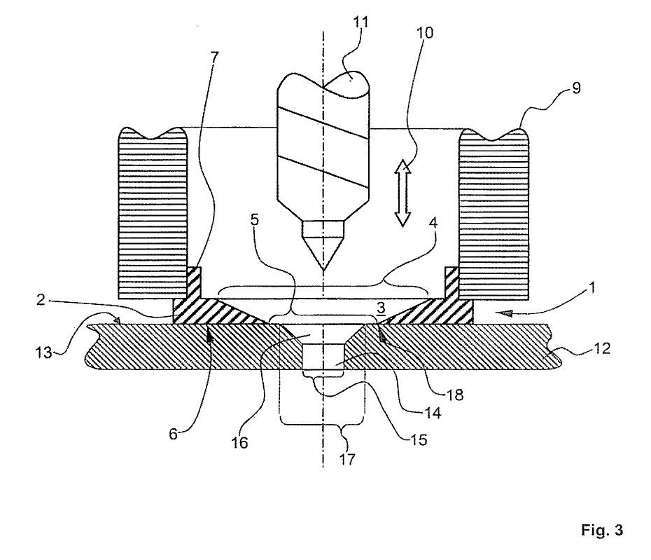

FIG. 2 shows a plan view on the insert according to an exemplary embodiment of the invention. The base body 2 of the insert 1 is substantially circular. The base body bore 3 is inserted in the base body 2 approximately centrally. The insert 1 comprises an outer diameter 8. According to an embodiment of the invention, the outer diameter 8 of the insert is approximately between 5 mm and 50 mm.

FIG. 3 shows a cross section through a pressure die bush as boring device comprising a press fitted insert 1. A borer 11 comprising a bore section and a countersink section is mounted within a pressure die bush 9 with the ability to move up and down in the direction of the arrow 10 for introducing a bore into a component 12 to be processed.

The base body 2 of the insert 1 is held in the pressure die bush 9 as boring device by means of the slightly pretensioned step 7. As a result of the slight press fit between the step 7 and the pressure die bush 9, the base body 2 may be, in case of need, for example upon reaching of the wear limit, easy to remove from the pressure die bush 9 and replaced by a new one.

The underside 6 of the base body 2 is in contact with a surface 13 of the component 12 to be processed and protects said surface from damage by rotating boring chips in the processing area. By lowering the borer 11, for example in the case of a combined countersink borer, a component bore 14 having a diameter 15 is first created in the component 12 by means of a bore section and the actual countersink bore 16 having the diameter 17 is subsequently created in the component 12.

According to the invention, the base diameter 5 of the base body bore 3 may herein be greater or equal to the opening diameter 17 of the countersink bore 16 or, in the case of a simple cylindrical bore, greater or equal to the diameter 15 of the bore 14 in the component 12. It is thereby ensured that, apart from the processing area, which is essentially equivalent to the area of the base body bore 3, the surface 13 of the component 12 is completely covered by the base body 2 and thus protected against damage due to rotating boring chips.

The base body bore 3 may be strongly tapered. The material thickness of the insert 1 may hereby be reduced to the value 0 in the area of the inner edge 18. A secure and accurate boring process may be ensured as a result of this strong tapering of the base body bore 3, since a borer may get stuck more readily in a cylindrical (guide) bore than in a tapered (guide) bore. Furthermore, the tapering of the base body bore 3 may ensure that also borers with a large outer diameter or a larger countersink diameter do not damage the base body 2 of the insert 1 by way of material ablation or thereby cause undesirably high and fast early wear.

The insert 1 configured according to the invention may enable bores or countersink bores in components with delicate surfaces to be created in a simple fashion without the danger of damage by rotating boring chips or suchlike, which may otherwise lead to significant post-processing costs.

### REFERENCE NUMERALS LIST

1 Insert

2 Base body

3 Base body bore

4 Opening diameter

5 Base diameter

6 Underside

7 Step

8 Outer diameter

9 Pressure die bush

10 Arrow

11 Borer

12 Component

13 Surface

14 Bore (Component)

15 Diameter

16 Countersink bore
(Component)

17 Opening diameter

18 Inner edge

1. An insert for a boring device, in particular for a countersink borer with depth stop or for a pressure die bush, the insert comprising:
a substantially circular base body; and
a base body bore disposed approximately centrally in the base body for passing a borer and/or a countersink borer through it;
wherein an underside of the base body is in contact with a surface of a component to be processed for protecting said surface; and
wherein a base diameter of the base body bore is greater or equal to a diameter of a bore to be created in the component or greater or equal to an opening diameter of a countersink bore.

2. The insert according to claim 1, wherein the base body bore is tapered.

3. The insert according to claim 1, wherein an opening diameter of the base body bore is greater than the base diameter of the base body bore.

4. The insert according to claim 1, wherein the base body is releasably mounted in the boring device by press fitting.

5. The insert according to claim 1, wherein the base body comprises at least one circumferential step for press fitting in the boring device.

6. The insert according to claim 1, wherein the base body is comprised of a soft plastic material.

7. The insert according to claim 1, wherein the base body is comprised of a soft metallic material.

8. The insert according to claim 6, wherein the base body is comprised of one of polyethylene, polypropylene and PTFE.

9. The insert according to claim 7, wherein the base body is comprised of one of aluminum, brass and copper.
